(19) United States
(12) Patent Application Publication
(10) Pub. No.: US 2014/0373995 A1
(43) Pub. Date: Dec. 25, 2014

(54) Pneumatic Tire

(71) Applicant: Bridgestone Corporation, Tokyo (JP)

(72) Inventors: Robert W. Handlos, Uniontown, OH (US); David G. Abdallah, JR., Tallmadge, OH (US); Maryangel G. Dunlavy, Ravenna, OH (US); Kent D. Weatherwax, Akron, OH (US)

(21) Appl. No.: 14/369,211

(22) PCT Filed: Dec. 31, 2012
(86) PCT No.: PCT/US2012/072259

§ 371 Date: Jun. 27, 2014

Related U.S. Application Data
(60) Provisional application No. 61/581,370, filed on Dec. 29, 2011.

(51) Int. Cl. B60C 15/00; B60C 9/02; B29D 30/08; B60C 1/00

(52) U.S. Cl. CPC B60C 15/0045; B60C 1/0041; B60C 9/02; B29D 30/08
USPC 152/552; 156/130.7

(57) ABSTRACT

A tire comprising a tread portion, a bead portion including a bead core, and a body ply including a turn-up portion positioned on an exterior of the tire, the turn-up portion of the body ply extending between said bead core and said tread and across a side portion of the tire.

This application claims the benefit of U.S. Provisional Application Ser. No. 61/581,370, filed Dec. 29, 2011, which is incorporated herein by reference.

### FIELD OF THE INVENTION

Embodiments of the present invention relate to pneumatic tires that are devoid of conventional sidewalls. In particular embodiments, the pneumatic tires are devoid of sidewall, while in other embodiments, thin sidewall components are provided.

### BACKGROUND OF THE INVENTION

It is well known that many characteristics or features of a pneumatic tire may impact its performance, wear, noise generation, and the like. One such feature is the weight of the tire. It is generally understood that a tire having greater weight will result in increased rolling resistance and increased heat generation. Accordingly, efforts have been made to reduce the weight of tires to improve the performance and other characteristics of the tire. Doing so, however, cannot sacrifice the other performance characteristics of the tire. Therefore, efforts to reduce tire weight offer great technical challenges.

### SUMMARY OF THE INVENTION

One or more embodiments of the present invention provide a tire comprising a tread portion, a bead portion including a bead core, and a body ply including a turn-up portion positioned on an exterior of the tire, the turn-up portion of the body ply extending between said bead core and said tread and across a side portion of the tire.

One or more embodiments of the present invention also provides a radial tire comprising a tread portion, a belt package, a pair of axially spaced bead portions, each bead portion including a bead core, and a carcass that is generally toroidal in shape and extends between said bead portions, said carcass including at least one reinforced body ply having a plurality of radially extending reinforcing cords and a turn-up portion extending from each bead core across a side portion of the tire to said tread portion, said body ply formed from a vulcanizate having a rubber component, the rubber component including between 30 and 80% natural rubber and a balance of synthetic rubber, said vulcanizate further including an antioxidant and an antiozonant.

One or more embodiments of the present invention also provides a radial tire comprising a tread portion, a bead portion including a bead core, and a body ply including a turn-up portion extending from said bead core to said tread portion across a sidewall portion of the tire, said body ply including a plurality of radial reinforcing cords, said cords positioned offset from a center of said body ply so that the cords are closer to a first surface than a second surface, said second surface being exposed on the sidewall portion of the tire.

One or more embodiments of the present invention also provides a radial tire comprising a tread portion, a bead portion including a bead core, and a body ply including a turn-up portion positioned on an exterior of the tire, the turn-up portion of the body ply extending between said bead core and said tread and across a side portion of the tire, where the tire is devoid of a separate sidewall component.

One or more embodiments of the present invention also provides a method of manufacturing a tire comprising the steps of forming a body ply having axial edges, the body ply including reinforcing cords extending radially between the axial edges of the body ply, where said reinforcing cords are off-set in at least a portion of the body ply, wrapping each axial edge of the body ply around a bead wire to form turn-up portions, the turn-up portions having a thickness of between approximately 0.055 and 0.150 inches, and positioning a tread over the body ply, wherein a shoulder of the tread is positioned proximate the axial edges of the body ply, the body ply forming a side portion of the tire.

### BRIEF DESCRIPTION OF THE DRAWINGS

FIG. 1 is a fragmentary sectional view of a portion of a pneumatic tire made according to one or more concepts of the present invention;

FIG. 1A is a sectional view of a portion of the pneumatic tire as indicated in FIG. 1;

FIG. 2 is a fragmentary cut-away perspective view of the pneumatic tire of FIG. 1; and

FIG. 3 is a fragmentary sectional view of a portion of a pneumatic tire made according to one or more concepts of the present invention.

### DETAILED DESCRIPTION OF THE ILLUSTRATIVE EMBODIMENTS

Embodiments of the present invention are based, at least in part, on the discovery of a pneumatic tire that is devoid of a conventional sidewall component. As the skilled person understands, conventional sidewalls are relatively thick components that are typically extruded and applied to the tire during the tire build. In particular embodiments, the pneumatic tires of this invention include a body ply turn up that extends from a bead portion of the tire to at least the shoulder of the tread and thereby spans at least substantially the entire side portion of the tire, which area has conventionally been covered by the sidewall. In specific embodiments, the body ply includes radial reinforcing cords that are positioned off center within the body ply so that a greater thickness of rubber is provided on the exterior of the body ply along the side portion of the tire. This increased rubber thickness on the exterior of the body ply advantageously provides added strength and protects the reinforcing cords in the absence of a conventional sidewall. In other embodiments, an insert is applied to the body ply to provide increased thickness along the side portion of the tire. In certain of these embodiments, the insert can extend to provide material for the formation of an abrasion strip. Advantageously, the skim rubber of the body ply and the insert may be formed from the same rubber composition.

The tires of this invention are advantageously light in weight due to the reduced thickness of the side region of the tire extending between the tread and bead portion. Also, the process for manufacturing the tires of certain embodiments is advantageous because a single compound can be used to form both the body and the side region of the tire, optionally together with the abrasion strip. As a result, the body ply, exterior side portion, and optionally the abrasion strip of the tire have the same composition.

### Tire Structure

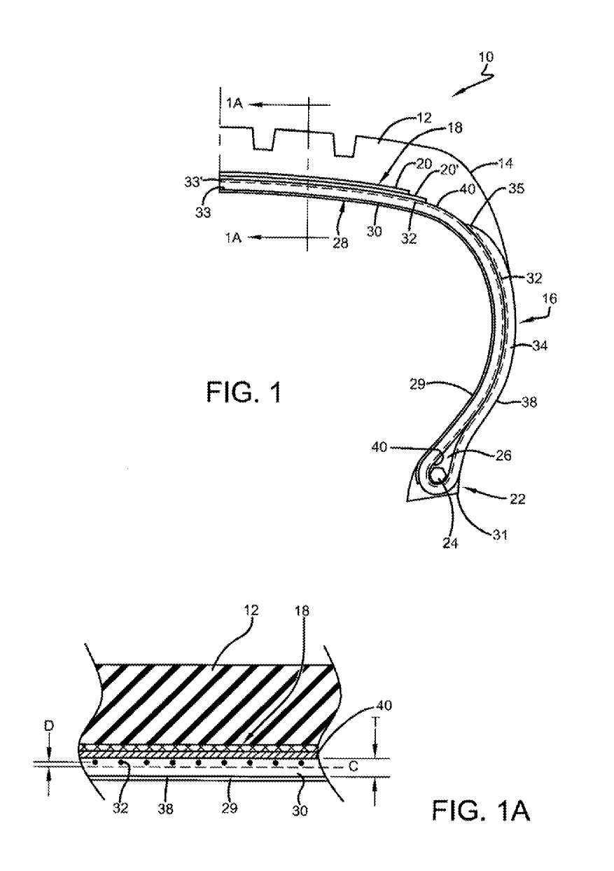

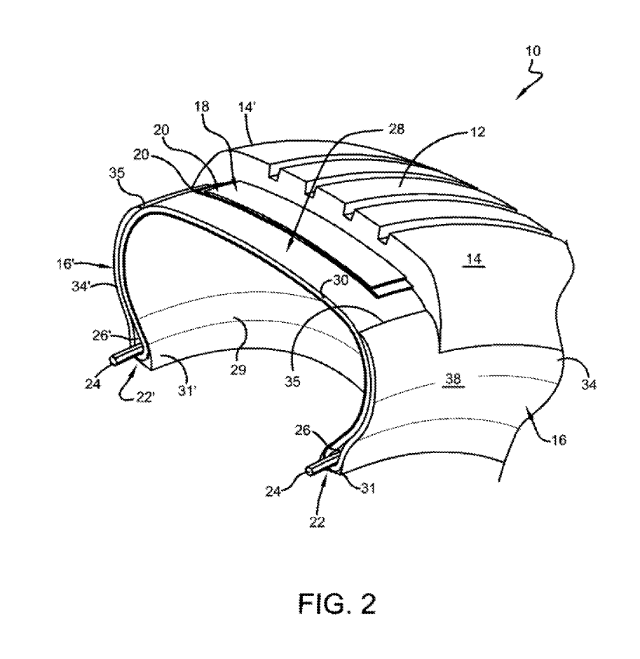

Referring now to FIGS. 1-2, portions of a pneumatic tire are shown, generally indicated by the numeral 10. It should be appreciated that the tire 10 shown in FIGS. 1-2 is not to scale, and some dimensions are exaggerated for the purpose of better depicting the invention. It will also be appreciated by those skilled in the art that one or more of the tire components referred to herein may be provided separately to a tire drum during construction of a tire and, after curing of the tire, the components largely cease to exist independent from other tire components due to the curing of the rubber components of the tire. Accordingly, reference to the various components of the tire may be viewed as a reference to those components prior to curing of the tire or to a reference of the location where the cured components exist. Also, while reference may be made to a component of one side of a tire, as for example shown in FIG. 1, the skilled person will understand that an equivalent component exists on the opposite side of the tire, as suggested by FIG. 2.

In one or more embodiments, tire 10 includes a tread 12, opposite side portions 16 and 16′, belt package 18, a pair of bead portions 22 and 22′, carcass 28, inner liner 29, and abrasion strips 31 and 31′. Unless otherwise specified herein, tire 10 may be manufactured consistent with the pneumatic tires as discussed in U.S. Pat. Nos. 5,866,171; 5,876,527; 5,931,211; and 5,971,046, all of which are incorporated herein by reference.

Tread 12, which extends circumferentially around tire 10, includes a shoulders 14 and 14′ at opposing axial edges where the tread 12 transitions to a side portions 16 and 16′ of the tire 10. In one or more embodiments, shoulder 14 refers to that portion of tread 12 where tread 12 transitions from a horizontal contact surface (i.e. where tire 10 contacts a road) to side portion 16, which may support the tread portion on a rim. The skilled person understands that tread 12 can be provided with any number of grooves, slots, and/or sipes to form varying tread patterns depending upon the intended use and performance of the tire.

In one or more embodiments, a belt package 18 is provided beneath tread 12. Belt package 18 may include one or more steel belts (e.g. belts 20 and 20′) extending circumferentially on an underside of the tread portion 12. In certain embodiments, the steel belts may be formed from woven strands of steel cord. The steel belts 20 provide a stable foundation for better tread wear and traction, and also provide protection against punctures.

Bead portions 22 and 22′, which are axially spaced, include respective bead cores 24 and 24′, which may also be referred to as a bead wires, and respective bead fillers 26 and 26′.

Carcass 28 is generally toroidal in shape and extends from one bead portion 22 to the other bead portion 22′ and is positioned beneath tread portion 12 and belt package 18. Carcass 28 includes one or more carcass plies (e.g. ply 30), which may also be referred to as body plies. The embodiment depicted in FIGS. 1-2 includes a carcass 28 having only a single body ply 30, but those skilled in the art will appreciate that two, three, or more body plies may be arranged in a stacked orientation to form the carcass 28.

In one or more embodiment, body ply 30 includes a cured rubber component 33, which may also referred to as a vulcanizate, and a plurality of body cords 32 that extend radially within the body ply 30 from one axial edge to the other. In one or more embodiments, body ply 30 is formed by coating opposing sides of a fabric with a rubber composition by using one or more calender roles; the fabric including body cords 32. To the extent that the rubber coated onto the opposing sides of the fabric forms rubber layers, reference may be made to body ply skims 33 and 33′; although the skilled person understands that these layers may not be mutually exclusive to the extent that the rubber penetrates though the fabric. Body ply skims 33 and 33′ derive from a vulcanizable rubber composition that typically includes other constituents, such as filler, that are dispersed throughout the cured rubber network of the vulcanizate. The rubber composition used to prepare the body ply skims is described in further detail below. In one or more embodiments, the body cords 32 extend in a direction parallel to the axis of the tire. During building of a green tire, the body cords 32 extend in a direction parallel to an axis of a drum, as will be appreciated by those skilled in the art.

The body cords 32 may be any known reinforcing cord suitable for use in the present application. Useful cords include those made from, for example, polyester, steel, fiberglass, or any other suitable metal or organic textile. In one or more embodiments, the body cords 32 may have a diameter greater than 0.20 mm, in other embodiments greater than 0.30 mm, in still other embodiments greater than 0.40 mm, and in still other embodiments greater than 0.50 mm; in the same or other embodiments the body cords 32 may have a diameter less than 2.0 mm, in other embodiments, less than 1.8 mm, in still other embodiments, less than 1.6 mm, and in yet other embodiments less than 1.4 mm.

The body cords 32 may be provided within the rubber composition in any desired density depending upon the cords used and the desired characteristics of the tire. In one or more embodiments, the body cords 32 may be spaced from adjacent body cords in the circumferential direction within the rubber composition by a distance of greater than 0.1 mm, in other embodiments greater than 0.5 mm, in still other embodiments greater than 1.0 mm, and in other embodiments greater than 1.5 mm; in the same or other embodiments, the body cords 32 may be spaced from adjacent body cords in the circumferential direction by a distance of less than 4.0 mm, in other embodiments less than 3.0 mm, in still other embodiments less than 2.5 mm, in yet other embodiments less than 2.0 mm, and still other embodiments less than 1.0 mm.

In one or more embodiments, one or more body plies 30 may include a turn-up portion 34 (and opposite turn-up portion 34′) that wraps around bead portion 22 (and 22′, respectively), and forms the exterior of the side portion 16 of the tire 10. In other words, the turn up portions of the body plies form the outermost layers or components of the tire in the side portion. This is in contrast to conventional tires, which include a sidewall layer applied to the side portion to cover the body ply.

In certain embodiments, the turn-up portion 34 of the body ply 30 may extend across the side portion 16 of the tire so that an axial edge 35 of the body ply 30 is positioned beneath the tread portion 12 adjacent to the shoulder 14 (as shown in FIGS. 1-2). In other embodiments, the turn-up portion 34 of the body ply 30 may extend across the side portion 16 of the tire so that the axial edge 35 is positioned proximate to the tread portion 12 (not shown). In certain embodiments, the entire side portion 16 of tire 10 between the tread portion 12 and bead portions 22, 22′ may include at least two layers of body ply 30 by virtue of the turn-up portion 34.

In one or more embodiments, where multiple body plies 30 are provided to form carcass 28, only one of the body plies 30 may include the turn-up portion 34 extending over the entire side portion 16. The other body plies 30 (not shown) may have a turn-up portion terminating at a point on the side portion 16 of the tire 10 between bead portions 22 and shoulder 14 of tread portion 12 consistent with known tire construction. In other embodiments, each of the multiple body plies, where more than one are provided, may include the turn-up portion 34 extending across the entire side portion 16. Thus, at least one single continuous body ply 30 extends between and wraps around bead portions 22 and includes opposing turn-up portions 34 forming the exterior surface of the side portions 16 of the tire 10. The body ply 30 forms adjacent layers of the side portion 16 of the tire 10 by virtue of it wrapping around the bead portion 22, with the body cords 32 of the two adjacent layers oriented parallel to one another. The turn-up portions 34 of body ply 30 are intended to replace a conventional sidewall as provided on known pneumatic tires. Accordingly, tire 10 may be devoid of a sidewall, as that term is understood in the field of pneumatic tires, which includes a separate element added to the side portion of the tire.

In one or more embodiments, body ply 30 may have an increased thickness as compared to known body plies in order to provide increased protection over the side portion 16. In certain embodiments, body ply 30 (prior to cure) may have a thickness of at least 0.060 inches, in other embodiments at least 0.070 inches, in still other embodiments at least 0.080 inches, and in yet other embodiments at least 0.090 inches. In these or other embodiments, body ply 30 may have a thickness between approximately 0.055 and 0.150 inches, in other embodiments between 0.060 and 0.120 inches, and in still other embodiments between 0.070 and 0.090 inches.

In one or more embodiments, the overall thickness of the side portion 16 of (after curing) may have a reduced thickness as compared to conventional tires; the reduced thickness stemming from the absence of a conventional sidewall component. In certain embodiments, the side portion 16 may have a thickness of no greater than 0.25 inches, in other embodiments no greater than 0.20 inches, in still other embodiments no greater than 0.18 inches, in other embodiments no greater than 0.16 inches, and in yet other embodiments no greater than 0.14 inches. The total thickness of the side portion 16 of tire 10 refers to the combined thicknesses of body plies (including any inserts in side portion) and turn-up portions between the bead portion and tread portion of the tire, excluding those parts of the side portion including a bead filler.

In one or more embodiments, the body cords 32 may be positioned off-center within body ply 30, as shown in the sectional view of FIG. 1A. Off-center, as used herein, refers to a location not on a centerline C that divides the thickness T of the body ply 30 in half. In one or more embodiments, the distance D that the body cords are spaced from centerline C may be greater than 0.01 inches, in other embodiments greater than 0.02 inches, in still other embodiments greater than 0.03 inches, and in yet other embodiments greater than 0.04 inches. In the same or other embodiments, the distance D that the body cords are spaced from centerline C may be less than 0.10 inches, in other embodiments less than 0.09 inches, in other embodiments less than 0.08 inches, in still other embodiments less than 0.07 inches, and in yet other embodiments less than 0.06 inches.

In one or more embodiments, the body cords 32 may be arranged off-center during the manufacturing process by providing skim layers of differing thicknesses. In other embodiments, the body cords 32 may be arranged off-center during the manufacturing process by calendering a second layer of rubber onto one side of the body ply, thereby adding thickness to that side of the body ply and causing the body cords 32 to be spaced a greater distance from one surface of the body ply. The additional layer of rubber may be substantially identical to the body ply skim rubber composition that applied to the cord in preparing the body ply.

In one or more embodiments, body ply 30 may include a first surface 38 that forms the outermost surface of side portion 16 of tire 10. Body ply 30 may also include a second surface 40 that faces bead wire 24 at the portion of body ply 30 that wraps around bead wire 24. In one or more embodiments, body cords 32 may be spaced from centerline C of body ply 30 in a direction opposite first surface 38, and closer to second surface 40. In this way, a body ply 30 is formed having an increased thickness of rubber adjacent to first surface 38 that forms the outermost layer of side portion 16.

In a particular embodiment, one or more additional layers of rubber may be applied to the body resulting in off-center cords 32. In one or more embodiments, the one or more additional layers of the rubber are applied to only the turn-up portions of the body ply resulting in off-center cords in only the turn-up portions; in particular embodiments, the cords in the remainder of the body ply may be centered within the thickness of the body ply. This additional layer of rubber may be referred to as an insert (or inserts) that can be applied to the body ply after the body ply skim rubber is calendered to the cord.

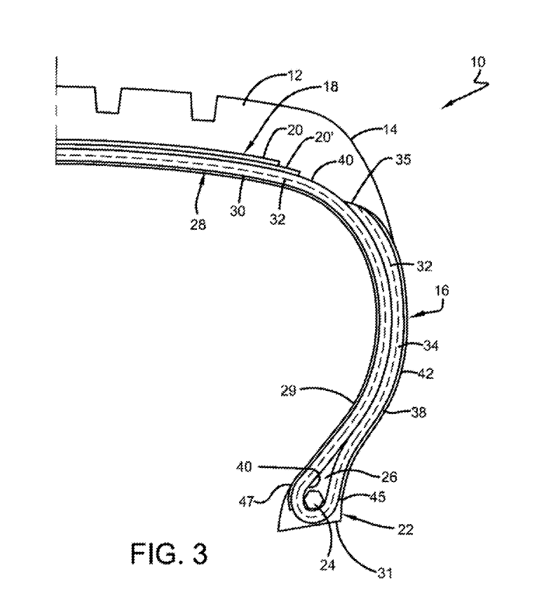

For example, and with reference to FIG. 3, tire 10 includes insert 42 applied to surface 38 of body ply 30 in turn-up portion 34. In one or more embodiments, the width of the insert applied to the turn-up portion may vary based upon the construction of the tire, and the skilled person can select an appropriate width to cover the turn-up portion once armed with the teachings of this invention. In one or more embodiments, the width of the insert extends from the edge of the body ply to a location of the body ply where an abrasion strip meets or is proximate to the side portion of the tire. In other words, and with reference to FIG. 3, the width of the insert is sufficient to cover body ply 30 from axial edge 35 to location 45 where abrasion 31 terminates at side portion 16. In other embodiments, the width of the insert extends from the edge of the body ply to the location of the body ply where an abrasion strip meets or is proximate to the inner liner of the tire. In other words, and again with reference to FIG. 3, the width of the insert is sufficient to cover body ply 30 from axial edge 35 to location 47 where abrasion strip 31 terminates on or proximate to inner liner 29.

In one or more embodiments, this insert has a thickness of at least 0.5 mm, in other embodiments at least 1.0 mm, and in other embodiments at least 1.5 mm. In these or other embodiments, this insert has a thickness of less than 5 mm, in other embodiments less than 3.5 mm, and in other embodiments less than 2.5 mm. In one or more embodiments, the thickness of the insert may range from about 0.5 to about 5 mm, in other embodiments from about 1.5 to about 3.5 mm, and in other embodiments from about 2.0 to about 3.0 mm. In these embodiments, the turn-up portions of the tire may have a thickness, including the additional layer of rubber, consistent with the thicknesses discussed above with respect to the body ply, and the remainder of the body ply without the additional layer of rubber may have a lesser thickness.

As should be appreciated, where the width of the insert is sufficient to cover bead portion 22, such as where the insert extends from axial edge 35 to innerliner 29, the insert can form abrasion strip 33 upon molding and curing using conventional techniques. Thus, practice of these embodiments of the invention advantageously provides a method whereby the insert can form the outermost portion of side portion 16 of tire 10 as well as abrasion strip 31. As a result, tires can be manufactured without the need to apply sidewalls and/or abrasion strips as separate components during tire build. Moreover, the same rubber composition can advantageously be used in the manufacture of the insert (i.e. the same rubber composition is used to form the body ply skim and the outermost portion of side portion 16), and optionally abrasion strip 31.

In yet other embodiments, multiple inserts are applied to the body ply to provide increased thickness in desired locations. For example, a first insert is applied to the body ply in the location of the side portion 16 and a second insert is applied to the body ply in the location of the abrasion strip 31. These inserts may advantageously employ the same rubber composition used in the manufacture of the body ply. In one or more embodiments, the use of the multiple inserts advantageously provides the ability to tailor the gauge of the insert at desired locations. For example, the insert applied to the body in the location of the side portion 16 (e.g. from about location 45 to location 35) may have a first thickness, while the insert applied to the body in the location of the abrasion strip 31 may have a second thickness. While FIG. 3 shows a splice line at 45, it should be appreciated that this splice line will not exist in those embodiments where only one insert is applied. In particular embodiments, the insert applied to the body ply in the location of the abrasion strip has a greater thickness than the insert applied in the location of the side portion 16. In one or more embodiments, both inserts may be calendered. In one or more embodiments, the insert applied to the body ply in the area of the abrasion strip may have a thickness in range from about 0.5 to about 5 mm, in other embodiments from about 1.5 to about 3.5 mm, and in other embodiments from about 2.0 to about 3.0 mm.

### Body Ply Skim Composition

In one or more embodiments, the vulcanizate of the body ply 30 (i.e. body ply skim) may include a rubber component and one or more additives dispersed throughout the rubber component, including, for example, one or more fillers, one or more oils, one or more cord adhesion promoters, one or more antidegredants, as well as sundry other ingredients that are conventional in the art. In one or more embodiments, the same rubber composition is used to prepare body ply 30 and insert 42, and therefore body ply 30, outer portion 16, and optionally abrasion strip 31 may be compositionally the same. Accordingly, reference to the ingredients used it the body plies will likewise refer to the ingredients that may be used in the insert.

The rubber component of the body ply skim may include one or more polymers that are capable of being crosslinked or vulcanized; these polymers may be referred to as rubber polymers or simply rubber. Useful rubber polymers include natural rubber, synthetic polyisoprene, polybutadiene, polyisobutylene-co-isoprene, neoprene, poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched and star shaped.

In one or more embodiments, the rubber component of the body ply skim may derive from a blend of natural rubber and one or more synthetic rubbers. In particular embodiments, the synthetic rubbers include polydiene or polydiene copolymers. In certain embodiments, the rubber component of the vulcanizate may derive from a blend of natural rubber and polybutadiene, polyisoprene, and/or copolymers of butadiene and isoprene. In one or more embodiments, the rubber component includes limited styrene-containing copolymers such as, but not limited to, poly(styrene-co-butadiene). In particular embodiments, the rubber component includes less than 5 wt %, in other embodiments less than 1 wt %, and in other embodiments less than 0.1 wt % styrene-containing copolymers. In particular embodiments, the rubber component of the body ply skim is substantially devoid of styrene-containing copolymers, which includes that amount or less than would otherwise have an appreciable impact on the practice of this invention.

These rubbers may be cured or crosslinked by employing a multitude of rubber curing agents including, but not limited to, sulfur or peroxide-based curing systems. Curing agents are described in Kirk-Othmer, Encyclopedia of Chemical Technology, 365-468, (3^{rd} Ed. 1982), particularly Vulcanization Agents and Auxiliary Materials, 390-402, and A. Y. Coran, Vulcanization in Encyclopedia of Polymer Science and Engineering, (2^{nd} Ed. 1989), which are incorporated herein by reference. Vulcanizing agents may be used alone or in combination. In one or more embodiments, the process of crosslinking or vulcanizing results in a three dimensional crosslinked infinite rubber network.

Fillers that may be employed in the skim rubber composition include inorganic and organic fillers. The organic fillers may include carbon black and starch. The inorganic fillers may include silica, aluminum hydroxide, magnesium hydroxide, clays (hydrated aluminum silicates), and mixtures thereof. In one or more embodiments, the body ply 30 is devoid or substantially devoid of inorganic filler such as silica.

In one or more embodiments, the body ply skim may include antioxidants, antiozonants, or both. These antioxidants and antiozonants may include those conventionally employed in the art of making tires. Examples include dialkyl-phenylene diamine, alkyl-aryl-phenylene diamine, carbamate, hindered phenol, hindered bis-phenol, amino-phenol, hydroquinone, phosphite, diphenylamine, naphthylamines, alkyldiamine, aldehyde-amine condensation product, quinoline, phenylenediamine (6PPD), trimethylquinoline (TMQ), and mixtures thereof.

In one or more embodiments, the body ply skim may include one or more adhesion promoters that promote and/or maintain adhesion between the fabric cord and the rubber matrix of the body ply skim. As those skilled in the art appreciate, adhesion promoters of this nature may be formed by combining methylene donor compounds and methylene acceptor compounds within the rubber composition. Examples of methylene acceptor compounds include phenols, which include hydroxylated derivatives of arenes and equivalent compounds. Specific examples include monophenols, such as hydroxybenzene, bisphenols, polyphenols (polyhydroxyarenes), substituted phenols such as alkylphenols or aralkylphenols, for example bisphenols, diphenylolpropane, diphenylolmethane, naphthols, cresol, t-butylphenol, octylphenol, nonylphenol, xylenol, resorcinol, or analogous compounds. In other embodiments, methylene acceptor compounds include phenolic resins. Useful phenolic resins include novolac resins (a.k.a. novolak resins), which are also referred to as two-stage resins. Novolac resins may be formed from an acid-catalyzed condensation reaction between excess phenol and an aldehyde, particularly formaldehyde. Resorcinol-novolac resins include those novolac resins that include the acid-catalyzed reaction product of resorcinol and an aldehyde.

Examples of methylene donor compounds include those compounds that are capable of reacting with a methylene acceptor to form a methylene bridge. Examples of methylene donors include hexamethylenetetramine (HMT), hexamethoxymethylmelamine (HMMM or H3M), hexaethoxymethylmelamine, N-(substituted oxymethyl) melamine, formaldemelamine derivatives, or mixtures of these compounds. As is known in the art, the methylene donor can be delivered in conjunction with an inert carrier such as silica.

Other ingredients that may be employed include accelerators, oils, waxes, scorch inhibiting agents, processing aids, zinc oxide, tackifying resins, reinforcing resins, fatty acids such as stearic acid, peptizers, and one or more additional rubbers.

In one or more embodiments, the rubber component of the body ply skim composition (as well as an insert) may include at least 30 wt. % natural rubber with the balance being synthetic rubber, in other embodiments at least 40 wt. % natural rubber, in other embodiments at least 50 wt. % natural rubber, in still other embodiments at least 55 wt. % natural rubber, and in yet other embodiments at least 60 wt. % natural rubber; in these or other embodiments, the rubber component of the body ply skim composition may include less than 80 wt. % natural rubber, in other embodiments less than 70 wt. % natural rubber, in other embodiments less than 60 wt. % natural rubber, in still other embodiments less than 55 wt. % natural rubber, and in yet other embodiments less than 50 wt. % natural rubber. In these or other embodiments, the rubber component of the body ply skim composition may include between about 30 and 80 wt. % natural rubber with the balance of the rubber component being synthetic rubber, in other embodiments between about 40 and 70 wt. % natural rubber, and in still other embodiments between about 50 and 60 wt. % natural rubber.

In one or more embodiments, the body ply skim composition includes at least 1.0 parts by weight (pbw), in other embodiments at least 1.5 pbw, in other embodiments at least 2.0 pbw, and in other embodiments at least 2.5 pbw antioxidant per 100 parts by weight rubber (phr). In these or other embodiments, the body ply skim composition includes less than 5 pbw, in other embodiments less than 4 pbw, in other embodiments less than 3.5 pbw, and in other embodiments less than 3 pbw antioxidant phr. In the same or other embodiments, the body ply skim composition may include between about 1.0 and 5 pbw, in other embodiments between about 1.5 and 4 pbw, in still other embodiments between about 2.0 and 3.5 pbw, and in yet other embodiments between about 2.5 and 3.0 pbw antioxidant phr.

In one or more embodiments, the body ply skim composition includes at least 0.1 pbw, in other embodiments at least 0.5 pbw, in other embodiments at least 1.0 pbw, and in other embodiments at least 1.5 pbw antiozonant phr. In these or other embodiments, the body ply skim composition includes less than 4.0 pbw, in other embodiments less than 3.5 pbw, in other embodiments less than 3.0 pbw, and in other embodiments less than 2.5 pbw antiozonant phr. In these or other embodiments, the body ply skim composition may include between about 0.1 and 4.0 pbw, in other embodiments between about 0.5 and 3.5 pbw, in still other embodiments between 1.0 and 3.0 pbw, and in yet other embodiments between 1.5 and 2.5 pbw antiozonant phr.

In one or more embodiments, the body ply skim composition includes at least 60 pbw, in other embodiments at least 70 pbw, and in other embodiments at least 80 pbw filler phr. In these or other embodiments, the body ply skim composition includes less than 120 pbw, in other embodiments less than 115 pbw, and in other embodiments less than 110 pbw filler phr. In the same or other embodiments, the body ply skim composition may include between about 60 and 120 parts by weight, in other embodiments between about 70 and 115 parts by weight, and in still other embodiments between about 80 and 110 pbw filler phr.

In one or more embodiments, the body ply skim composition includes at least 0.5 pbw, in other embodiments at least 1.0 pbw, in other embodiments at least 1.5 pbw, and in other embodiments at least 2.0 pbw adhesion promoter (e.g. the product of a methylene donor and acceptor) phr. In these or other embodiments, the body ply skim composition includes less than 5.0 pbw, in other embodiments less than 4.0 pbw, and in other embodiments less than 3.0 pbw adhesion promoter phr. In the same or other embodiments, the body ply skim composition may include between about 1.0 and 4.0 parts by weight, in other embodiments between about 1.5 and 3.5 parts by weight, and in still other embodiments between about 2.0 and 3.0 pbw adhesion promoter phr.

In one or more embodiments, the vulcanizate of the body ply 30 may be characterized by a Shore A hardness (per ASTM D2240) of less than 70, in other embodiments less than 65, and in other embodiments less than 60; in these or other embodiments, the vulcanizate of the body ply 30 may be characterized by a Shore A hardness of greater than 50, in other embodiments greater than 55, and in other embodiments greater than 60. In the same or other embodiments, the vulcanizate of the body ply 30 may be characterized by a Shore A hardness (per ASTM D2240) of between approximately 50 and 70, and in other embodiments between 55 and 65. In a particular embodiment, the vulcanizate of the body ply 30 may be characterized by a Shore A hardness (per ASTM D2240) of approximately 60.

In one or more embodiments, the vulcanizate of the body ply 30 can be characterized by a stress at 100 percent strain (per ASTM D412) of less than 8 mPa, in other embodiments less than 7 mPa, and in other embodiments less than 6 mPa; in these or other embodiments, the vulcanizates of the body ply 30 can be characterized by a stress at 100 percent strain of greater than 2 mPa, in other embodiments greater than 3 mPa, and in other embodiments greater than 4 mPa. In the same or other embodiments, the vulcanizate of the body ply 30 can be characterized by a stress at 100 percent strain (per ASTM D412) of between 2 and 8 mPa, in other embodiments between 3 and 7 mPa, and in still other embodiments between 4 and 6 mPa.

### Manufacture of the Pneumatic Tire

The tires of this invention can generally be fabricated by employing conventional rubber mixing, calendering, shaping, molding, and curing techniques. Exemplary manufacturing techniques as disclosed in U.S. Pat. Nos. 5,866,171; 5,876,527; 5,931,211; and 5,971,046, which are incorporated herein by reference. The skilled person will able to adjust the manufacturing process to fabricate tires according to the present invention once armed with the teachings herein.

As suggested above, the body plies employed in one or more embodiments of the present invention may be fabricated by coating a cord fabric with a skim rubber compound by using calendering techniques, which are generally known in the art. Where the cords are off-set within the body ply, the body ply may be fabricated by providing skim rubbers layers of varying thicknesses. In other embodiments, the off-set may be accomplished by calendaring a second layer of rubber onto the one side of the body ply. In still other embodiments, an insert may be applied to a calendered body ply. For example, in a first step, a body ply is prepared by using conventional techniques to calendar rubber to the body ply. Once prepared, an insert, which may include an extruded or calendered sheet of rubber, may be applied to the body ply. In particular embodiments, as suggested above, this insert may applied only a portion or portions of the body ply so that the insert is located in the side portion of the tire and optionally the location of the abrasion strip. After application of the insert, pressure may be applied to the insert and/or body ply in order mate the elements and remove any air entrapped between the elements. In one or more embodiments, the pressure applied to the mated elements does not impact the gauge of the laminate that is formed.

Once the body ply or plies are prepared, the prepared components of the tire 10, including, for example, the innerliner 29, carcass 28 (including any plies having an insert applied thereto), belt package 18, tread portion 12, and bead wires 24 are assembled around a drum. In one or more embodiments, manufacture of the tire 10 may include the step of wrapping the body ply 30 around bead wires 24 at each bead portion 22, 22′ and folding the body ply 30 back upon itself to form the turn-up portions 34. In certain embodiments, the tread portion 12 may then be positioned over a portion of each of the turn-up portions 34 of body ply 30.

Following assembly the tire 10 may be cured or vulcanized. In one or more embodiments, vulcanization can be effected by heating the vulcanizate within a mold. In one or more embodiments, the composition can be heated at a temperature from about 140° C. to about 180° C. The cured or crosslinked rubber compositions (i.e., vulcanizates) generally include three-dimensional polymeric networks that are thermoset. Other ingredients, such as processing aids and fillers are generally dispersed throughout the vulcanized network.

### INDUSTRIAL APPLICABILITY

The pneumatic tires according to one or more embodiments of the present disclosure may useful on high performance vehicles, and may provide improved performance as a result of the reduced weight of the tire. The tires may also be useful on other vehicles, including passenger vehicles, light truck, and off-road vehicles, where improved tire performance is desired.

Various modifications and alterations that do not depart from the scope and spirit of this invention will become apparent to those skilled in the art. This invention is not to be unduly limited to the illustrative embodiments set forth herein.

What is claimed is:

1-29. (canceled)

30. A tire comprising:
a tread portion, a bead portion including a bead core, and a body ply including a turn-up portion positioned on an exterior of the tire, the turn-up portion of the body ply extending between said bead core and said tread and across a side portion of the tire.

31. The tire of claim 30, where the tire is devoid of a separate sidewall component.

32. The tire of claim 30, where said body ply includes a first surface that forms the outermost exposed surface of the side portion of the tire, a second surface opposite said first surface, and a plurality of radially extending reinforcing cords positioned within said body ply between said first and second surfaces, where said reinforcing cords are positioned offset from a center of said body ply, the cords being closer to said second surface of said body ply than said first surface of said body ply.

33. The tire of claim 32, where said reinforcing cords are spaced from a center of said body ply by between 0.02 and 0.08 inches, where said reinforcing cords have a diameter of between approximately 0.20 and 2.00 mm, where said reinforcing cords are spaced from adjacent body cords by a distance of between 0.10 and 4.00 mm, and where said body ply having a thickness of greater than about 0.060 inches.

34. The tire of claim 30, further comprising an inner liner positioned on an interior of the tire, and a belt package extending around said body ply in the direction of travel of the tire.

35. The tire of claim 30, where said body ply includes a rubber component that is the vulcanized product of natural rubber and a polydiene, where said rubber component includes between 30 and 80% natural rubber, at least 1.0 part by weight antioxidant per 100 parts by weight of rubber, at least 1.0 part by weight antiozonant per 100 parts by weight of rubber, at least 1.0 parts by weight adhesion promoter per 100 parts by weight of rubber, and at least 1.0 parts by weight filler per 100 parts by weight rubber.

36. The tire of claim 30, where the tire is fabricated by applying an insert to the body ply, and where said insert extends between said bead core and said tread so as to form the outermost surface of the side portion of the tire.

37. The tire of claim 36, where the body ply includes a rubber component and a reinforcement, and where the rubber component and the insert are compositionally the same.

38. The tire of claim 36, where the tire is fabricated by applying at least one insert to the body ply, and where said insert forms the outermost surface of the side portion of the tire and an abrasion strip located adjacent to the bead core portion.

39. The tire of claim 38, where rubber component of the bead core and the at least one insert are compositionally the same.

40. A radial tire comprising:
a tread portion;
a belt package;
a pair of axially spaced bead portions, each bead portion including a bead core, and
a carcass that is generally toroidal in shape and extends between said bead portions, said carcass including at least one reinforced body ply having a plurality of radially extending reinforcing cords and a turn-up portion extending from each bead core across a side portion of the tire to said tread portion, said body ply formed from a vulcanizate having a rubber component, the rubber component including between 30 and 80% natural rubber and a balance of synthetic rubber, said vulcanizate further including an antioxidant and an antiozonant.

41. A radial tire comprising:
a tread portion;
a bead portion including a bead core; and
a body ply including a turn-up portion extending from said bead core to said tread portion across a sidewall portion of the tire, said body ply including a plurality of radial reinforcing cords, said cords positioned offset from a center of said body ply so that the cords are closer to a first surface than a second surface, said second surface being exposed on the sidewall portion of the tire.

42. A radial tire comprising:
a tread portion;
a bead portion including a bead core; and
a body ply including a turn-up portion positioned on an exterior of the tire, the turn-up portion of the body ply extending between said bead core and said tread and across a side portion of the tire, where the tire is devoid of a separate sidewall component.

43. A method of manufacturing a tire comprising the steps of:
forming a body ply having axial edges, the body ply including reinforcing cords extending radially between the axial edges of the body ply, where said reinforcing cords are off-set in at least a portion of the body ply;
wrapping each axial edge of the body ply around a bead wire to form turn-up portions, the turn-up portions having a thickness of between approximately 0.055 and 0.150 inches; and
positioning a tread over the body ply, wherein a shoulder of the tread is positioned proximate the axial edges of the body ply, the body ply forming a side portion of the tire.

44. The method of claim 43, where the step of forming a body ply includes forming a body ply having a generally uniform thickness of between approximately 0.055 and 0.150 inches, and where the total thickness of the side portion of the tire formed by wrapping the body ply around the bead wires is no greater than 0.25 inches.

45. The method of claim 43, where a separate sidewall component is not positioned over the side portion of the tire prior to curing the tire.

46. The method of claim 45, further comprising the step of applying an insert to the body ply to thereby off-set said reinforcing cords.

47. The method of claim 46, where the insert has a width sufficient to form an abrasion strip proximate to a bead portion of the tire, or where a second insert is applied to the body ply to thereby provide for an abrasion strip proximate to a bead portion of the tire.

48. The method of claim 46, where the body ply is prepared by coating a fabric including the reinforcing cords with a rubber composition by calendering, further comprising the step of forming an insert by calendering a rubber composition, and further comprising the step of laminating the insert to the body ply.

49. The method of claim 48, where the rubber composition for coating the fabric and the rubber composition for forming the insert are compositionally the same.
